(19) United States
(12) Patent Application Publication
(10) Pub. No.: US 2010/0176967 A1
(43) Pub. Date: Jul. 15, 2010

(54) COLLECTING UTILITY DATA INFORMATION AND CONDUCTING RECONFIGURATIONS, SUCH AS DEMAND RESETS, IN A UTILITY METERING SYSTEM

(76) Inventors: Scott Cumeralto, Spokane, WA (US); Matthew Johnson, Spokane, WA (US); Mark K. Cornwall, Spokane, WA (US)

Correspondence Address: DORITY & MANNING, P.A., POST OFFICE BOX 1449, GREENVILLE, SC, 29602-1449, US

(21) Appl. No.: 12/521,593

(22) PCT Filed: Jan. 4, 2008
(86) PCT No.: PCT/US08/50285

§ 371 Date: Mar. 19, 2010

Related U.S. Application Data
(60) Provisional application No. 60/883,490, filed on Jan. 4, 2007.

(51) Int. Cl. G08C 15/06

(52) U.S. Cl. 340/870.02

(57) ABSTRACT

In a data collection system having a utility data collector configured for remotely collecting utility data, a system includes one or more endpoints. Each endpoint has a utility meter, memory for storing at least utility consumption data from the utility meter, and a radio for transmitting a communication message to the utility data collector. The radio establishes a communication link between the endpoint and the utility data collector, and provides consumption data when a wireless communication channel quality test determines an adequacy of communications from the endpoint and the utility data collector (e.g. using RSSI). The utility meter sets a hold-off timer or other validity check and only performs subsequently received reset requests or other reconfigurations if the timer has expired or the validity check is valid. Other features are also disclosed.

### CROSS-REFERENCE TO RELATED APPLICATION

This application claims priority to U.S. Provisional Patent Application No. 60/883,490, filed Jan. 4, 2007, entitled “Mobile Demand Reset,” which is herein incorporated by reference, in its entirety, including appendices.

### BACKGROUND

Five to ten percent of electric utility meters are installed on what are known as C&I (Commercial and Industrial) accounts, which often have large-scale power needs. The utility meters installed on such C&I accounts are typically more sophisticated than the basic residential watt-hour meter. For example, these meters may measure more parameters than simple watt-hour consumption, including time of use (TOU) and demand values that represent the highest, or peak, power demand over a unit of time. Typically, such demand data is accumulated over a billing cycle that is approximately one month in length. Accordingly, as part of collecting consumption, demand, and TOU data, it is desirable for a utility to be able to reset a meter (particularly the demand value) after information collection takes place, which typically occurs once every billing cycle.

In many of today's systems, the demand value at a meter is reset by: physically depressing a switch button on the meter, initiating a reset function from a handheld or laptop computer via a serial optical probe and serial data connection, or using an automatic timer or calendar feature that is programmed into the meter. In such systems, recognition of the reset event is not provided proof-positive to the meter reader and inference rules must be applied. This impacts the business rules of many utilities and is not desirable. In addition, some of these approaches disconnect the demand reset from the meter read and results in a mismatch of timestamps that is not favored by utilities.

Other systems may allow a demand reset command to be sent to a meter/endpoint device (e.g., via a radio transmission) but do not provide any confirmation that the command was received and executed, resulting in erroneous readings and, ultimately, an unreliable system. Some of the possible undesirable scenarios that might occur in such systems include the following: (a) a data collector sends multiple demand reset requests (in order to ensure that reset occurs) and peak demand is inadvertently reset more than once during a short time period, which causes the loss of peak demand information between readings; (b) a demand reading transmission from meter/endpoint to collector fails and the meter reader receives incomplete data or no data at all, requiring repeated transmission attempts, which is highly inefficient. In a mobile collection or reading environment, such inefficiency can be compounded by further retransmissions to subsequent end points due to the short time the mobile is in optimal range of the end point.

Readings of peak demand information, consumption information, TOU information, and/or other meter-related data are typically made over a serial data connection from a handheld or laptop computer with an attached serial optical probe, which queries various data storage components (e.g., ANSI C 12.19 registers) in the meter to obtain and calculate the desired readings for the utility. Such readings may also be made via radio transmission sent from a meter/endpoint and collected by some type of radio enabled collector system/device. However, there is often the concern that such transmissions may be at least partially unsuccessful and may need to be repeated.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a schematic diagram of a mobile collection system showing a mobile collector and multiple meters/endpoints having both one-way and two-way wireless connectivity.

FIG. 2A is a block diagram showing an example of a mobile collector and a two-way meter/endpoint, which employ aspects of the invention.

FIG. 2B is a block diagram showing a more detailed view of the data storage at the meter/endpoint shown in FIG. 2A.

FIG. 3 is a message exchange diagram that shows aspects of the invention as implemented during a successful demand reset and demand data request transaction that occurs between a meter/endpoint and a mobile collector that communicate employing a 100S protocol.

FIG. 4 is a message exchange diagram similar to the message exchange diagrams of FIGS. 3 and 4, but shows additional aspects of the invention, including a hold off timer operation, as implemented during an unsuccessful demand reset and demand data request and retry.

FIG. 5 is a flow diagram illustrating an example of a demand reset process at a meter or end point.

FIG. 6 is a flow diagram showing an example of a routine showing a routine at a collector for analyzing RSSI.

Note: the headings provided herein are for convenience and do not necessarily affect the scope or interpretation of the invention.

### DETAILED DESCRIPTION

Various examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

### Representative System

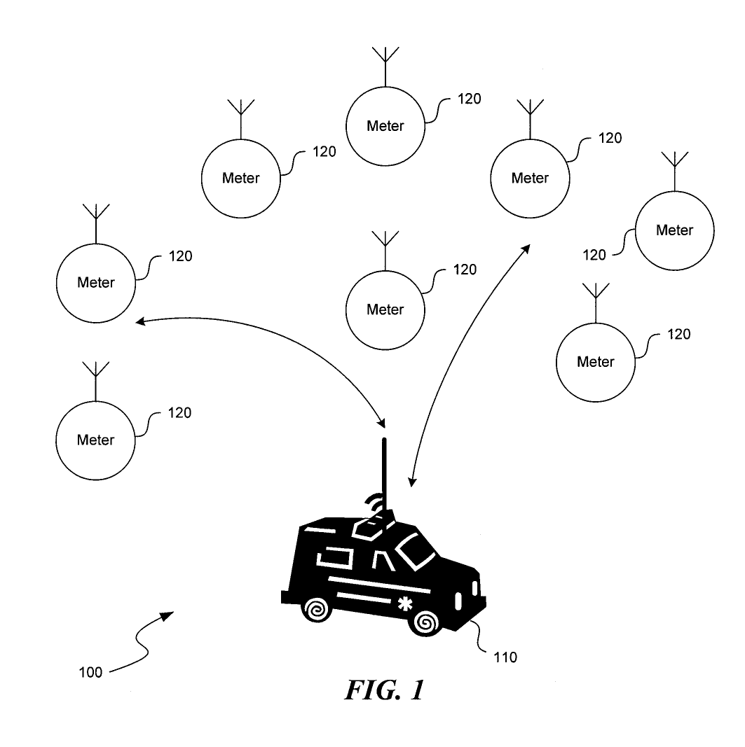

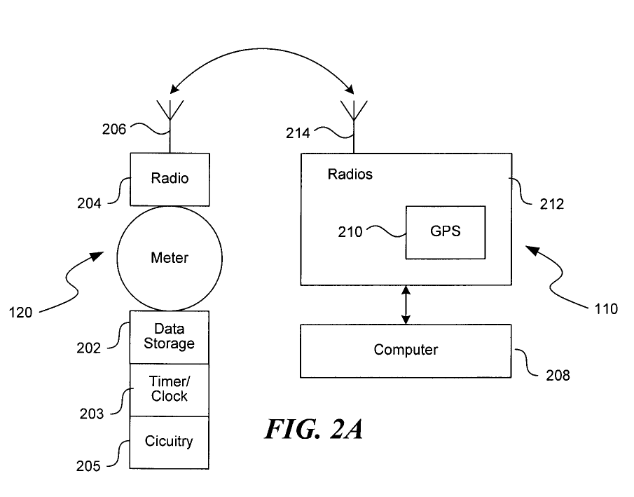

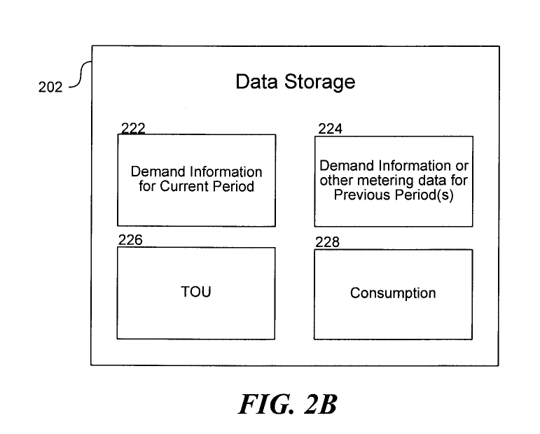

FIGS. 1, 2A, 2B and the following discussion provide a brief, general description of a suitable environment in which aspects of the invention can be implemented. Although not required, aspects and embodiments of the invention will be described in the general context of radio communications and/or computer-executable instructions, such as routines executed by a general-purpose computer, e.g., a server or personal computer. Those skilled in the relevant art will appreciate that the invention can be practiced with other system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. Aspects of the invention can be embodied in a special purpose computer or data processor or by using other circuitry that is specifically programmed, configured or constructed to perform one or more of the activities explained in detail below. Indeed, the term “computer”, as used generally herein, refers to any of the above devices, as well as any data processor or any device capable of communicating with a network, including consumer electronic goods such as game devices, cameras, or other electronic devices having a processor and other components, e.g., network communication circuitry.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

More specifically, FIGS. 1 and 2A show aspects of a sample utility data collection environment 100 in which a collection system/device 110 can be used to collect utility data (e.g., consumption data, time of use (TOU) data, peak demand data, etc.) from one or more remotely located meters/endpoints 120 using radio-based mobile/remote techniques. (The terms “meter” and “endpoint” are generally used interchangeably herein, as are the terms “collection system”, “collector”, “reader” and “drive-by unit”.) In the case where the one or more of the meters/endpoints 120 is associated with a C&I account, the system of FIGS. 1 and 2A allows a demand reset function to be initiated via radio, for example, while the collection system/device 110 is collecting reads (e.g., from other meters on a meter route). In general, however, while performing the meter reading route, the collection system/device 110 may coordinate the reading of one-way meters with the two-way demand reset meters seamlessly to maintain the high read reliability the utility has come to expect from reading just one-way meters.

While a vehicle based collection system 110 is illustrated in FIG. 1, various types of reader devices may be used (either alone or in combination) to implement the collection system/device 110. These include but are not limited to a handheld mobile reader, a fixed remote reader, etc.

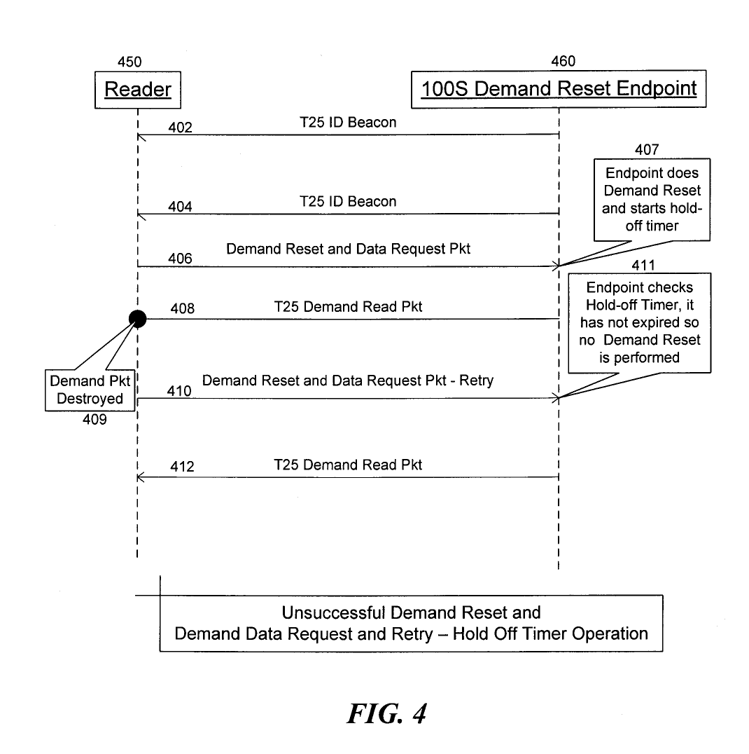

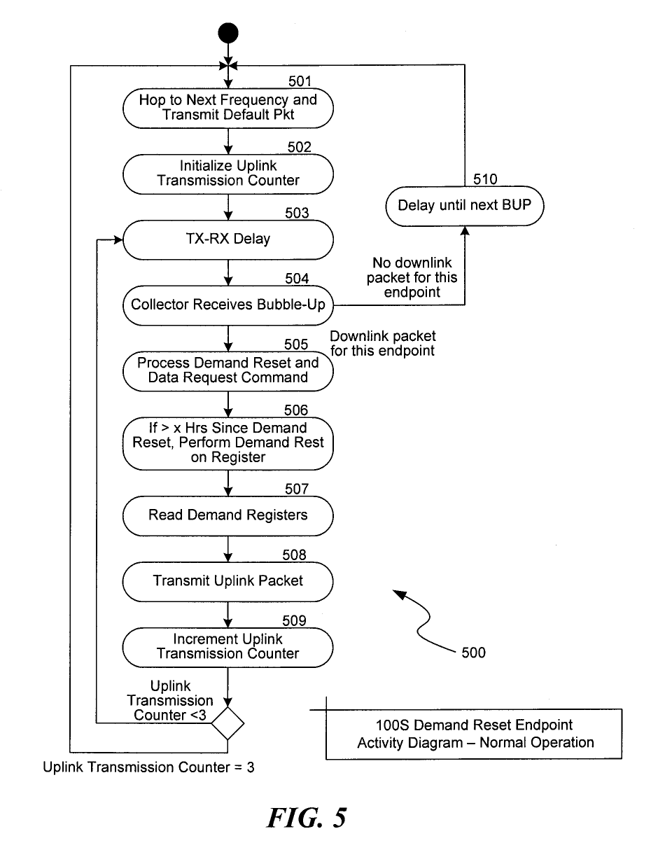

As illustrated in FIG. 2A, a representative meter/endpoint 120 of the collection environment 100 includes a data storage component 202, a timer and/or clock 203 (optional), a radio module 204, basic circuitry 205, and an antenna 206. In addition to allowing the meter 120 to track time-of-use data related to consumption of the utility, the timer and/or clock 203 may allow the meter 120 to perform functions such as setting a demand reset hold-off, as described in more detail with respect to FIGS. 4 and 5. The basic circuitry 205 within the meter 120 may be analog and/or digital circuitry that allows the meter/endpoint to perform functions such as switching from a bubble-up (one-way) mode of communication to a two-way mode of communication, preparing/formatting packets of requested data to send out to the collection system/device 110, clearing, setting, and resetting registers of the data storage component 202 as appropriate (e.g., satisfying a demand reset request), setting and operating timers (e.g., performing a time sync operation, setting a demand reset hold-off timer, etc.), interfacing with the radio module 204, etc. The complexity of the circuitry 205 within respective meters 120 of the utility data collection environment 100 may vary based on the type of account (e.g., residential versus commercial) and other factors (e.g., one-way only or two-way, etc.).

The collection system/device 110 comprises at least one computer 208 having one or more processors, a GPS module, and at least one radio receiver/transceiver 212 that communicate with the meters 120 via an antenna 214 using one-way and/or two way radio communications. Various radio communication/modulation schemes may be used to facilitate RF communications between the meters 120 and the collection system/device 110. These may include a single channel high speed FM link, on-off key (OOK) transmissions (which may improve uplink performance for long packets of data), frequency-shift keying (FSK), or other high speed radio links. Note that a GPS module is not required, but any other device or method may be employed. For example, any source of precision time in the reader for resetting clocks in the meters may be employed; GPS is just one suitable method of implementation.

The computer 208 of the collection system/device may have mapping and/or meter reading software installed upon it, as well as an associated operating system. The collection system 110 (e.g., via its computer 208 or other features) may allow for user interaction via one or more input/output devices (e.g., screen, keyboard, touch pad, mouse/pointing device, microphone, joystick, pen, game pad, scanner, digital camera, video camera, printer, plotter, speakers, tactile or olfactory output devices, etc.). The collection system 110 (e.g., via its computer 208 or other features) may optionally be coupled to external systems/computers via a network connection, wireless transceiver, etc. Accordingly the computer 208 may include features such as a connection port to a network such as a local area network (LAN), wide area network (WAN) or the Internet.

FIG. 2B shows a more detailed view of the data storage component 202 of the system. The data storage 202 component may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMS, ROMs, smart cards, etc.

The data storage component 202 may be configured, for example, as multiple registers, or in other storage configurations. In the illustrated embodiment, the data storage component 202 is configured using a first storage subcomponent 222 for storing demand information for a current time period (e.g., the time period beginning immediately following the most recently executed demand reset) and a second storage subcomponent 224 for storing demand information for one or more previous periods (e.g., a time period ending immediately before the most recently executed demand reset, and possibly previous time periods). In addition, the data storage component 202 includes a TOU storage subcomponent 226 to store time of use data and one or more additional storage subcomponents 228 to store consumption data. The data storage component thus may store multiple pieces of data, any of which may be provided to the collection system. Thus, the meter/endpoint may transmit for storage at the collection system 110 previous demand alone, and/or other data, such as previous TOU, etc.

The arrangement of the storage component 202 and subcomponents 222, 224, 226 and 228 of FIG. 2B is intended to illustrate, generally, the types of information stored at the meter/endpoint 120. Certainly, the technology described herein may be implemented using other data storage configurations including storage configurations that comply with industry standards, such as the ANSI C 12.19 standard for TOU and Demand meters, which is a standard commonly used in the United States. The C 12.19 Demand Reset/TOU register typically stores various reading-related parameters in sets of registers. The radio module in the meter takes the desired readings from these sets of registers and packetizes them for transmission to the reader/collector. The register may also contain serial interfaces to connect to external computers as well as the radio module. The C 12.19 Demand Reset/TOU register typically includes a battery-backed clock for maintaining time which is used to capture time-related meter readings. The register can also maintain a calendar that is used to close out demand periods by performing a demand reset based on a schedule in the calendar. Since the serial data rate to most TOU registers is quite slow, and multiple registers may need to be manipulated mathematically to obtain the desired reading, the radio may periodically download this information from the register and cache it, so that the two-way radio transaction will be faster.

### Communication Flows

The sample system described above with respect to FIGS. 1 and 2A and 2B may use a two-way protocol (e.g., the 100 Series Two-Way Protocol) to implement its demand read and/or reset functionality. Of course, other messages or protocols may be employed, such as a combination of SCM messages and Type 25 variable message length format, which provide a natural migration path from traditional equipment and protocols, or optionally Bluetooth, Zigbee or WIFI protocols modified for vehicular operation. Traditionally these commercially available protocols may not be viable for fast moving mobile operation due to excessive acquisition time, signaling performance in a fading environment and typical RF power limitations. However, any wireless protocol may be employed with aspects of the systems described herein.

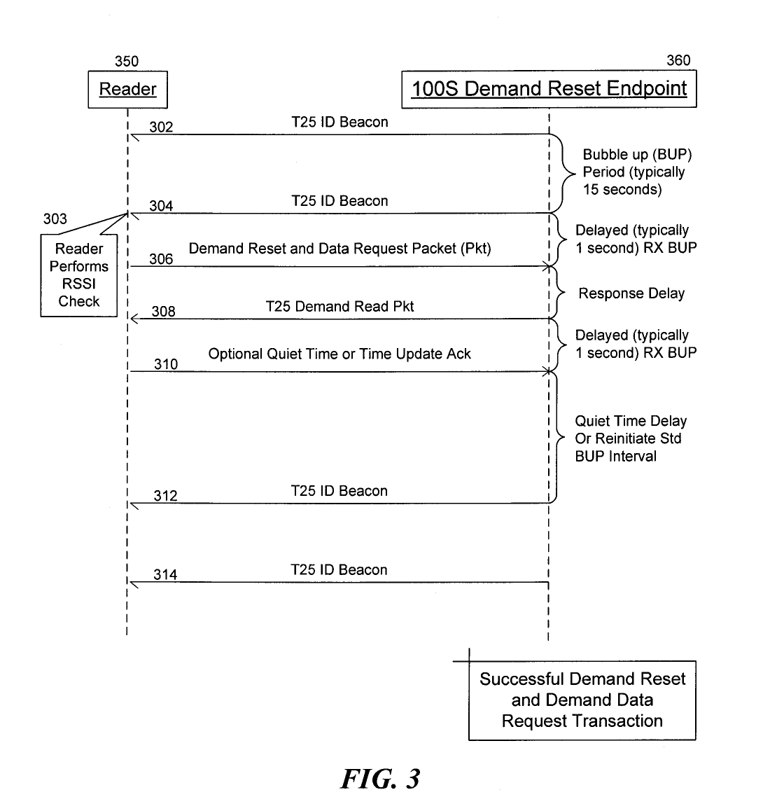

FIGS. 3 and 4 show two scenarios under the 100 Series Two-Way protocol, which utilizes Type 25 message (T25) for communications under the 100 Series Two-Way protocol. The 100 Series protocol may include transmission of an initial (short) message of at least an endpoint's identification. The endpoint then turns off its transmitter to save on battery power, and enters a listen mode for any instructions from the reader, such as, for example, a request for additional information. If the endpoint receives these instructions during its listen period, the endpoint responds as instructed. If the endpoint does not receive a response from the reader, the endpoint enters a sleep mode until its next transmit time to, once again, save battery power. The endpoint may transmit a standard consumption message (SCM) via AM communication. Immediately, upon transmitting the AM communication, the endpoint transfers into a two-way, FM receive/transmit mode. When the reader receives the SCM, the reader requests additional information from the endpoint and the endpoint transmits that additional information via two-way FM communication. Further, the endpoint may save intervals of utility meter data where interval data is capable of being transmitted by the endpoint in either AM or FM. In this instance, the reader, upon detecting the endpoint, transmits a command to the endpoint to send a predetermined number of intervals over a predetermined communication channel or channels. Other details regarding the 100 Series protocol may be found, for example, in the above-referenced provisional application, or in the assignee's published U.S. patent application no. 2007-0057812 entitled “RF METER READING SYSTEM,” filed Sep. 9, 2005.

The T25 messages may be used in automatic meter reading (AMR) systems to employ versatile radio packets. Versatile radio packets are recognizable by conventional (legacy) AMR system receivers capable of receiving conventional interval data message (IDM) packets, where “recognizing” means that conventional receivers are able to detect versatile packets, or can relatively easily be upgraded (e.g. by reprogramming) to be able to detect the versatile radio packets. Versatile radio packets are versatile in the sense that the packets are capable of carrying a wide variety of information items of various lengths. For example, versatile radio packets can carry consumption information including present consumption value and interval data representing a set of past consumption values (which may be a relatively long message), or they can carry an alarm message indicating a service outage (which is typically a relatively short message). Versatile radio packets can enable endpoint and other devices in the system to transmit a variety of new information to existing AMR infrastructure without having to conduct a significant infrastructure overhaul.

A versatile radio packet may include a packet preamble portion, a packet body portion, and a packet validation portion. The packet preamble portion may have a frame synchronization bit sequence recognizable by existing or conventional encoder-receiver-transmitter (ERT)-based AMR system receivers, such a bit sequence 0×16A3. The packet preamble portion may also have a packet type identifier field and a packet length field. The packet body portion includes at least an endpoint serial number field and a message, where at least the message has a variable length. Optionally, the message includes a message type identifier field and a message value field that can have multiple sub-fields. The message can include data originating from an endpoint or from an intermediate AMR system device such as a repeater. Other details regarding the T25 message may be found, for example, in the above-referenced provisional application, or in the assignee's published U.S. patent application no. 2007-0211768 entitled “VERSATILE RADIO PACKETING FOR AUTOMATIC METER READING SYSTEMS,” filed Feb. 5, 2007.

In particular, FIG. 3 illustrates a successful read and demand reset communication flow 300, which utilizes, at least in part, the 100 Series Two-Way protocol. The communication flow 300 begins with two T25 bubble-up messages 302 and 304 transmitted from an endpoint 360, approximately 15 seconds apart. These bubble-up messages 302 and 304 are intended for receipt by the reader 350 and contain minimum necessary information typically needed for a meter reading function. The information may include endpoint Identification number, tamper flag information such as physical or magnetic tamper, consumption information and check sum or CRCC. By utilizing a basic message and validating it via the CRCC during message reception and RSSI determination, an accurate and reliable message can be verified to enable proper nearly simultaneous RSSI level determination However, in the present example, it can be assumed that the first of the two bubble-up messages 302 is not received at the reader 350, because it is the receipt of the second bubble-up message 304 at the reader that triggers the beginning of two-way communications, including the demand rest and data request packet sent at communication 306.

In some embodiments, the reader 350 performs received signal strength indicator (RSSI) testing of the received bubble up communications (box 303) and delays the beginning of two-way communications, and more particularly the transmission of a demand reset command (e.g., communication 306) if a certain predetermined RSSI threshold is not met. In other words, the reader 350 measures the RSSI of the bubble-up transmissions from the endpoint 360 and only attempts two-way communications when the RSSI is sufficiently high enough for a high likelihood of a successful transmission on the first attempt. Because a collector/reader operating in a transmission mode cannot typically receive readings from endpoints until transmission is complete, this approach, which helps to ensure effective two-way communications on the first attempt, minimizes the amount of time lost where the reader cannot receive data transmissions.

The use of an RSSI threshold in the above-described application is highly effective, as it factors in dynamic, real-world RF propagation characteristics at the time of communication and accounts for localized path loss and interference conditions (buildings, basement meter locations, etc.). Furthermore, the RSSI threshold may be adjustable/variable, based on current conditions. The RSSI testing of the bubble-up communications may be implemented using any of a number of techniques, including one or more circuits configured to measure the RF level of the received bubble-up communication. In addition, a signal-to-noise ratio factor may be considered in the RSSI testing and in setting of the threshold. While the above description discusses measuring RSSI, it may be possible to implement the technology using other signal quality measurements, such as bit error rate (BET) testing.

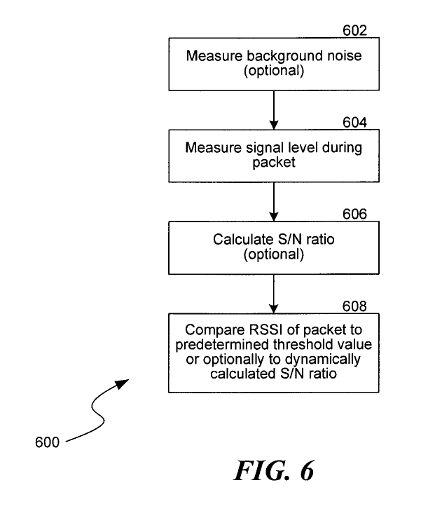

Signal to noise levels can be determined on a per channel basis and thus on going communication can be directed to channels to avoid interference. In one example, the system measures a signal to noise ratio (S/N) by comparing the RSSI level of time intervals just before or after a message from the endpoint to determine a background noise level. This is compared with the signal level during the message to determine the S/N level. As shown in FIG. 6, a routine 600 may optionally measure background noise (block 602) and then measure the signal level of a received packet (block 604). In block 606, the system may optionally calculate a S/N from the received signal and the measured background noise. In block 608, the system compares the RSSI of the packed to a predetermined threshold value, or optionally to a dynamically calculated S/N value.

In addition or as an alternative to performing RSSI testing, another way to help insure the success of two-way communications is to configure the meter/endpoint so that it increases its RF power output at the start of two-way communications to increase the likelihood of success on the first attempt at a two-way transaction, while still conserving power when not in a two-way mode.

Referring back to communication 306, the start of two-way communications between the endpoint and the reader, the reader sends a packet containing a demand reset command and data request. There may be multiple advantages to sending the demand reset command and data request in a single packet, including minimizing the time that the reader spends transmitting, as well as timing power/bandwidth conservation considerations. The system may always, or nearly continuously, send time in an initial request packet to reduce the number of transactions, which could optimize bandwidth.

In response to successfully receiving communication 306, the endpoint 360 performs a demand reset (see box 307) and sends out, in communication 308, a T25 demand read packet containing peak demand information. After communication 308 the reader optionally sends a time update (communication 310), and it is assumed that the two-point communication session is completed successfully. Accordingly, the endpoint reinstates a standard bubble-up interval as demonstrated by communications 312 and 314.

Another implementation of the demand reset technology is shown in FIG. 4. In this implementation, the endpoint/meter meter 460 includes a hold-off timer. This hold-off timer is started shortly following receipt, from the reader 450, of a packet 406 containing a demand data request and demand reset command. More specifically, in response to receiving the demand data request/demand reset command packet 406 (which, in this example, is preceded by two bubble-up transmissions, 402 and 404, sent from the endpoint) the endpoint 460 sends out a packet 408 containing the requested demand information. In addition, as shown in box 407, the endpoint 460 performs a demand reset and starts the hold-off timer, steps that are explained in more detail with respect to FIG. 5 and the associated textual description.

In the event that the packet 408 containing the requested demand information is subsequently lost or otherwise not received by reader 450 (as shown in box 409) the action of setting of the hold-off timer prevents a subsequently received demand reset command (e.g., communication 410) from being executed at the endpoint 460 while the hold-off timer is still running. For example, after realizing that it has yet to receive the requested demand data, the reader 450 (which, in the case of a mobile collection system, may still be performing a driving route around the area of the endpoint 450) may send a duplicate demand data request/demand reset packet (e.g., communication 410) under the assumption that the first demand request/demand reset packet (e.g., communication 406) was not received at the endpoint. If it were not for the setting of the hold-off timer, the endpoint 460 would perform a second demand reset, even though it had just performed a demand reset just seconds (or minutes) before. Undesirably, these back to back demand resets if left to occur, may result in the creation of a very short demand interval that is inconsistent with the regular billing cycle period. Thus, the demand reset hold-off timer functionality described above prevents the creation of an inadvertent, very short (e.g. the few seconds between the initial demand reset command and the retry) demand interval, and therefore preserves the integrity of the system.

An example of a suitable demand reset hold-off period might be 24 hours so that the likelihood of the reader resetting the meter more than once while driving a route for the day will be eliminated. While the hold-off timer is described in this example, the system may implement other timer related processes, such as time-stamping transactions and comparing them to one or more time stamps of the last transaction and the meter's clock to determine whether a message was received within or outside of a hold-off period.

In some embodiments, the hold-off can be programmed over-the-air (OTA) from the collector where adjustments are required after the meter has been deployed (with no special trip or programmer required). Of course, the system may employ other types of OTA programming, such as correcting the meter's clock, changing TOU schedules, configuration programming of register(s), changing data stored or associated with other registers, etc. In addition to setting the hold-off timer, the meter/endpoint may flag if there was any subsequent unexecuted resets so that follow-up action may be taken if necessary. For example, the flagging of such an event and a related indication sent to the driver or operator of the reader/collector may indicate the need for a drive or walk by in case that problem exists.

FIG. 5 is a flow diagram illustrating an example of a demand reset process 500 performed at a meter or end point, and shows the effects of a demand reset hold-off timer. In this particular example, the endpoint is also attempting a frequency shift scheme for two-way communications, in which it varies the RF frequency that it uses to send out its uplink communications. More specifically, under this frequency shift scheme, the endpoint transmits the same uplink message on multiple frequencies (all known to the reader) and at different times to increase the read reliability for two way uplink communications. This may reduce the need to retry transmissions in variable multipath environments.

At block 501, the endpoint hops to a first desired frequency and transmits the endpoint's default packet (e.g., a bubble-up packet that if received, indicates that the endpoint is within range). At block 502, the endpoint initializes an uplink transmission counter that allows it to switch frequencies after a predetermined number of uplink packets have been sent out on a given frequency (in this example, the specified number is 3). At block 503, the endpoint engages in a transmit/receive delay. In this example, it is assumed that the collector/reader receives the transmitted bubble-up packet sent at block 504. In block 504, the endpoint turns on its receiver and the collector transmits a downlink packet under a 2-way transaction. Next, if the endpoint does not receive from the collector/reader a downlink packet containing a demand reset request and a data request after the initial delay (block 503), the endpoint delays again at block 510 and then the process loops back to block 501, where the endpoint begins its bubble-up packet transmission on a new frequency. Otherwise, the endpoint continues to block 505 to process the received downlink packet containing a demand reset command and data request.

At block 506, the endpoint checks to see whether it should perform the demand reset request. More specifically, it checks a hold-off timer function. If it has been more than a predetermined number of hours (e.g., 24 hours) since the last demand reset, the hold-off timer has expired and the endpoint performs the requested demand reset. Otherwise, the assumption is that the requested demand reset is a duplicate request, and the endpoint does not perform the demand reset. At block 507, the endpoint reads one or more of its demand registers. More specifically, if a demand reset has recently occurred (i.e., the hold-off timer has not expired), the endpoint may read a demand register storing information from the previous billing cycle, under the assumption that the reader did not receive a previous demand information uplink packet that was recently sent out from the endpoint. However, if a demand reset has not recently occurred, the endpoint may read (and then clear) its current demand data register(s), and then store this information in the register for the previous billing cycle, making it available for any follow-up requests, at least until the next billing cycle.

At block 508, the endpoint transmits, to the reader/collector, an uplink packet containing the requested information read from the appropriate demand registers. At block 509, the endpoint increments the uplink transmissions counter. Following block 509, if the uplink transmission counter has a value less than 3 (the maximum counter value used in this example), the process 500 loops back to stage 503. Otherwise, the process 500 loops back to stage 501.

In addition to the various aspects of the system that are described herein, the system may optionally or alternatively include other aspects that allow for the successful transmission of demand or other data and/or successful demand reset or other reconfiguration. For example, in some embodiments, the data from multiple registers in the meter may be structured in sub-packets with individual error detection and acknowledgements (ACK mapping) to minimize the amount of data required to be retransmitted if a packet collision occurs. Likewise, in some embodiments, diversity reception may be used to improve reception during RF fading conditions to minimize retransmissions. In the case of electric meters (which do not have the battery constraints of gas and water meters) the meter's receiver might be turned on multiple times or continuously between the meter's bubble-up transmissions to increase the availability of the meter to do two-way communications. In some embodiments, non-ISM band radio frequencies may be utilized for downlink communications (from the collector to the meter). The use of another non ISM-frequency may help to minimize lost reception time due to in-band transmission from the collector. This could facilitate performing additional communication sessions (e.g., using the ANSI C 12.19 communication standard) to interrogate additional registers to meet special reading or programming needs without special visits to the meter, although it might require the reader to stop briefly to perform the longer set of transactions. In such a case, the system may provide some sort of indication to the operator/user of the reader/collector.

In addition to the hold-off timer, or as an alternative to it, the meter may transmit its data, the collector tells the meter it has received the data, and then an acknowledgement (Ack) is provided to confirm a reset is now possible because the meter knows that the collector has received the data. Alternatively or additionally, the system may exchange sequence counters (or the meter may provide a sequence known to the collector) for the reset, where the collector knows a previous sequence counter (e.g. last month's counter value) when it arrives at the meter so that it and/or the meter can compare the new sequence number to the one that was established during last month's visit.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

While certain aspects of the invention are presented below in certain claim forms, the inventors contemplate the various aspects of the invention in any number of claim forms. For example, while only one aspect of the invention is recited as a means-plus-function claim under 35 U.S.C §112, sixth paragraph, other aspects may likewise be embodied as a means-plus-function claim, or in other forms, such as being embodied in a computer-readable medium. (Any claims intended to be treated under 35 U.S.C. §112, 116 will begin with the words “means for”.) Accordingly, the inventors reserve the right to add additional claims after filing the application to pursue such additional claim forms for other aspects of the invention.

We claim:

1. At a utility data collector configured for remotely collecting utility data from one or more endpoints that include a utility meter, a method comprising:
receiving a one-way type communication message from the endpoint, wherein the endpoint and the utility data collector are configured to communicate with each other using both one-way and two-way communications;
based on receiving the one-way type communication message, performing a received signal strength indicator (RSSI) test to determine an adequacy of a communication link to be established between the endpoint and the utility data collector; and
if a threshold is met for the RSSI test, initiating two-way communications between the endpoint and the utility data collector to gather at least utility consumption data.

2. The method of claim 1 wherein utility meter is configured for reading peak demand values and wherein the two-way communications include sending a demand reset command to the endpoint.

3. The method of claim 1 wherein performing the RSSI test includes measuring an amplitude of at least one received one-way type communication message packet.

4. The method of claim 1 wherein performing the RSSI test includes considering a signal-to-noise ratio associated with the received one-way type communication message.

5. The method of claim 1 wherein the received one-way type message is a bubble-up message.

6. In a data collection system having a utility data collector configured for remotely collecting utility data, a system comprising:
one or more endpoints, wherein each endpoint comprises:
a utility meter;
memory means for storing at least utility consumption data from the utility meter;
radio means for transmitting a communication message to the utility data collector; and,
wherein the radio means further comprises means for establishing a communication link between the endpoint and the utility data collector, and for providing at least the utility consumption data from the utility meter, when a wireless communication channel quality test determines an adequacy of communications from the endpoint and the utility data collector.

7. The system of claim 6 wherein the wireless communication channel quality test is a received signal strength indicator (RSSI) test, and wherein the utility data collector performs the RSSI test.

8. The system of claim 6 wherein utility meter and memory means are configured for reading and storing peak demand values, and wherein the radio means further comprises two-way communications means for receiving a demand reset command.

9. The system of claim 6 wherein the communications message is a one-way bubble-up message.

10. The system of claim 6 wherein the radio means further comprises means for receiving a command for correcting a clock of the endpoint, changing a time of use (TOU) schedule, or configuration programming of the storage means.

11. At a utility endpoint configured to communicate wirelessly with a utility data collector system over a radio communication link, the endpoint comprising a utility meter configured, at least in part, for reading peak demand data, a method comprising:
receiving a first request for a demand reset from the utility data collector system;
based on receiving the first request, performing the requested demand reset and setting a demand reset hold-off timer; and
if a subsequent request for a demand reset is received during a period associated with the demand reset hold-off timer, not performing the subsequently requested demand reset unless the demand reset hold-off timer has expired.

12. The method of claim 11 wherein the demand reset hold-off timer expires approximately one day after being set, and wherein a timer period may be user-programmable to other durations.

13. The method of claim 11 further comprising, if a subsequent request for a demand reset is received before the demand reset hold-off timer has expired, setting a flag to indicate receipt of the request.

14. In a system where a utility endpoint communicates wirelessly with a utility data collector over a radio communication link, wherein the utility endpoint gathers utility consumption data, an apparatus comprising:
means for receiving a first reset request message from the utility data collector;
means for performing a first requested reset, wherein the first requested reset requests reconfiguration of at least a portion of the utility endpoint;
means for receiving a second reset request message; and,
means for performing a validity check and performing a second requested reset only if the validity check is acceptable.

15. The apparatus of claim 14 wherein the means for performing a validity check comprises means for a setting a hold-off timer based on the first reset request message or the first requested reset, and not performing the second requested reset during a period associated with the hold-off timer.

16. The apparatus of claim 14 wherein the means for performing a validity check comprises means for comparing sequence counter values.

17. The apparatus of claim 14 wherein the means for performing a validity check comprises means for receiving a confirming message after successful receipt of utility consumption data by the utility data collector.

18. The apparatus of claim 14 wherein the first requested reset comprises performing a demand reset, correcting a clock of the utility endpoint, changing a time of use (TOU) schedule of the utility endpoint, or configuration programming of storage means of the utility endpoint.
